(19) United States
(12) Patent Application Publication
(10) Pub. No.: US 2018/0261885 A1
(43) Pub. Date: Sep. 13, 2018

(54) NONAQUEOUS ELECTROLYTE AND LITHIUM SECONDARY BATTERY INCLUDING THE SAME

(71) Applicant: LG Chem, Ltd., Seoul (KR)

(72) Inventors: Hyun Yeong Lee, Daejeon (KR); Hyea Eun Han, Daejeon (KR); Chul Haeng Lee, Daejeon (KR); Yu Ra Jeong, Daejeon (KR)

(73) Assignee: LG Chem, Ltd., Seoul (KR)

(21) Appl. No.: 15/761,268

(22) PCT Filed: Nov. 15, 2016
(86) PCT No.: PCT/KR2016/013125

§ 371 Date: Mar. 19, 2018

(30) Foreign Application Priority Data
Nov. 18, 2015 (KR) 10-2015-0161754

(51) Int. Cl. H01M 10/0567; H01M 10/0569; H01M 10/0568; H01M 10/0525

(52) U.S. Cl. CPC H01M 10/0567; H01M 10/0569; H01M 2300/004; H01M 10/0525; H01M 10/0568

(57) ABSTRACT

The present invention relates to: a nonaqueous electrolyte having an excellent swelling suppressing effect during high-temperature storage; and a lithium secondary battery including the same.

### TECHNICAL FIELD

### Cross-Reference to Related Application

This application claims priority to and the benefit of Korean Patent Application No. 10-2015-0161754, filed on Nov. 18, 2015, the disclosure of which is incorporated herein by reference in its entirety.

### Technical Field

The present invention relates to a non-aqueous electrolyte and a lithium secondary battery including the same, and particularly, to a non-aqueous electrolyte which has an excellent effect of suppressing a swelling phenomenon when stored at high-temperature, and a lithium secondary battery including the same.

### BACKGROUND ART

Recently, as interest in energy storage technology is increasing and the technology has been widely applied to various fields such as mobile phones, camcorders, notebook PCs and electric vehicles, efforts for research on and development of electrochemical devices have materialized.

In this respect, electrochemical devices have attracted the most attention, and interest in secondary batteries that can be charged and discharged among these is increasing. Particularly, among secondary batteries that are currently being used, a lithium secondary battery developed in the early 1990s is getting the most attention due to its high operating voltage and superior energy density.

The lithium secondary battery is composed of a negative electrode made of a carbon material that can occlude and release lithium ions, a positive electrode made of a lithium-containing oxide, and a non-aqueous electrolyte in which an appropriate amount of a lithium salt is dissolved in a mixed organic solvent. The charge and discharge of the lithium secondary battery are performed while a process of intercalating and deintercalating lithium ions from a lithium metal oxide of the positive electrode to a graphite electrode as the negative electrode is repeated.

Meanwhile, structural stability and capacity of the lithium secondary battery are determined in accordance with the occlusion and release of lithium ions in a lithium-transition metal oxide or a composite oxide used as a positive electrode active material. For example, a lithium ion reacts with a carbon electrode due to its high reactivity to form Li₂CO₃, LiO, LiOH or the like, and thus a film is formed on a surface of a negative electrode. The film is denoted as a solid electrolyte interface (SEI) film, wherein the SEI film formed at an initial stage of charging, once being formed, prevents a reaction of lithium ions with the negative electrode or other materials during repetitive charge and discharge occurring by using the battery. Also, the SEI film acts as an ion tunnel through which only lithium ions pass between the electrolyte and the negative electrode. The ion tunnel solvates lithium ions and thus serves to prevent the destruction of a structure of the carbon negative electrode due to the co-intercalation of the lithium ions and organic solvents, which are contained in an electrolyte, have a high molecular weight, and move along with the lithium ions, into the carbon negative electrode. Therefore, in order to improve high-temperature cycle and low-temperature output characteristics of the lithium secondary battery, a robust SEI film must be formed on the negative electrode of the lithium secondary battery.

Recently, as the lithium secondary battery has been widely applied to various fields, there is an increasing demand for a lithium secondary battery that can be safely charged even at high voltage while maintaining excellent cycle lifespan characteristics even in harsher environments such as high or low-temperature, high-voltage charging, or the like.

However, a non-aqueous electrolyte that has been developed so far does not include an electrolyte additive or mainly includes an electrolyte additive having poor characteristics, and thus it is difficult to expect an improvement in high-temperature output characteristics due to the formation of an uneven SEI film.

### PRIOR-ART DOCUMENTS

Korean Patent Application Publication No. 10-2015-00451562
Korean Registered Patent No. 10-40464

### DISCLOSURE

### Technical Problem

The present invention is designed to solve the problems of the prior art, and it is one aspect of the present invention to provide a non-aqueous electrolyte including an additive capable of forming a more stable film on a surface of a negative electrode.

In addition, it is another aspect of the present invention to provide a lithium secondary battery having improved swelling characteristics when stored at high temperature by including the non-aqueous electrolyte.

### Technical Solution

In order to accomplish the above objectives, according to one embodiment of the present invention, there is provided a non-aqueous electrolyte which includes a lithium salt; an organic solvent; and an additive, wherein the organic solvent includes a cyclic carbonate and a linear carbonate, and the additive includes a compound represented by Formula 1 below.

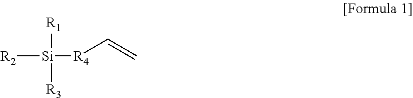

In Formula 1,
R₁ to R₃ are each independently a C1 to C3 alkyl group, and R₄ is a C1 to C3 alkylene group.

According to another embodiment of the present invention, there is provided a lithium secondary battery which includes a negative electrode, a positive electrode, a separator interposed between the negative electrode and the positive electrode, and the non-aqueous electrolyte according to the present invention.

### Advantageous Effects

The present invention provides a non-aqueous electrolyte including an electrolyte additive capable of suppressing the decomposition of an electrolyte by forming a more stable film on a surface of a negative electrode at high-temperature so that an amount of lithium ions, which are consumed when a battery is initially charged, is minimized, and thus a lithium secondary battery having not only an effect of suppressing a swelling phenomenon but also improved initial capacity and an improved capacity retention rate when stored at high temperature can be manufactured.

### BEST MODE

Hereinafter, the present invention will be described in more detail.

Terms and words used in this specification and claims should not be interpreted as limited to commonly used meanings or meanings in dictionaries and should be interpreted with meanings and concepts which are consistent with the technological scope of the invention based on the principle that the inventors have appropriately defined concepts of terms in order to describe the invention in the best way.

As described above, a conventional SEI film formed using a carbonate-based organic solvent is electrochemically or thermally unstable, and thus may be easily broken due to electrochemical energy and thermal energy, which are increased as charging and discharging proceed. Therefore, a SEI film is continuously regenerated during charging and discharging of a battery, thus capacity of a battery may be reduced, and lifespan performance of a battery may be degraded. Also, a side reaction such as decomposition of an electrolyte may occur on a negative electrode surface exposed due to the destruction of a SEI film, and a problem in which a battery is swelled or the internal pressure thereof increases may occur due to gas generated by the decomposition.

Accordingly, the present invention provides a non-aqueous electrolyte including an additive, which is capable of forming a more stable SEI film.

In addition, the present invention provides a lithium secondary battery which includes the non-aqueous electrolyte so that a swelling phenomenon is suppressed and initial capacity and a capacity retention rate are improved even when stored at high temperature.

Specifically, according to an embodiment of the present invention, there is provided a non-aqueous electrolyte including a lithium salt; an organic solvent; and an additive, wherein the additive includes a compound represented by Formula 1 below.

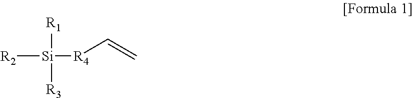

In Formula 1,
R₁ to R₃ are each independently a C1 to C3 alkyl group, and R₄ is a C1 to C3 alkylene group.

More particularly, the additive may include a compound represented by Formula 1a below.

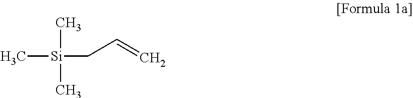

The additive may be included at 0.1 to 1 part by weight, preferably, 0.1 to 0.5 parts by weight based on 100 parts by weight of the non-aqueous electrolyte. When a content of the additive is less than 0.1 parts by weight, an effect of forming a stable SEI film may be insignificant, and when a content thereof is greater than 1 part by weight, the internal resistance of a battery increases according to an additive content, and thus it is difficult to obtain sufficient capacity and charge/discharge efficiency.

Generally, during an initial charging process of a secondary battery, an electrolyte is decomposed before lithium ions released from a positive electrode are intercalated into a negative electrode (graphite) and thus a SEI film which affects a reaction of the battery is formed on a surface of the negative electrode (graphite). This film not only has a property of allowing lithium ions to pass therethrough and blocking movement of electrons but also serves as a protective film for preventing an electrolyte from being continuously decomposed. However, it is difficult to continuously maintain the performance of the generated SEI film, and the SEI film is broken due to contraction and expansion caused by a repetitive charging/discharging cycle or heat and impact from the outside. As the SEI film thus broken is recovered during a continuous charging and discharging process, electric charge is additionally or irreversibly consumed, and thus a continuous decrease in reversible capacity is caused. Particularly, as a thickness of a solid film generated by the decomposition of an electrolyte increases, interfacial resistance increases, and thus battery performance is degraded.

Since the additive included in the non-aqueous electrolyte according to the present invention includes silicon atoms in a structure of a compound, the silicon atoms form an inorganic film on a surface of a negative electrode, and thus a continuous reaction between the surface of a negative electrode and a solvent may be suppressed at high temperature. Therefore, gas generation which occurs when a battery is stored at high temperature may be suppressed to more efficiently prevent a swelling phenomenon. Also, the additive includes an allyl group with a double bond, and thus the allyl group with a double bond is electrically reduced to form an allylic radical having resonance, and an intermediate having stable energy compared to a functional group with a single bond may be formed. Therefore, an allylic radical structure formed by reductive decomposition may form a more stable organic film on an electrode surface at high temperature.

Therefore, lithium ions may be smoothly occluded and released from a negative electrode even at high temperature, thereby a secondary battery having significantly improved overall performance such as room-temperature and high-temperature lifespan characteristics may be manufactured.

In addition, in the non-aqueous electrolyte according to the present invention, the lithium salt may be a lithium salt commonly used in an electrolyte for a lithium secondary battery without limitation. For example, the lithium salt includes Li⁺ as a cation, and any one selected from the group consisting of F⁻, Cl⁻, Br⁻, I⁻, NO₃⁻, N(CN)₂⁻, BF₄⁻, ClO₄⁻, AlO₄⁻, AlCl₄⁻, PF₆⁻, SbF₆⁻, AsF₆⁻, BF₂C₂O₄⁻, BC₄O₈⁻, (CF₃)₂PF₄⁻, (CF₃)₃PF₃⁻, (CF₃)₄PF₂⁻, (CF₃)₅PF⁻, (CF₃)₆P⁻, CF₃SO₃⁻, C₄F₉SO₃⁻, CF₃CF₂SO₃⁻, (CF₃SO₂)₂N⁻, (F₂SO₂)₂N⁻, CF₃CF₂(CF₃)₂CO⁻, (CF₃SO₂)₂CH⁻, (SF₅)₃C⁻, (CF₃SO₂)₃C⁻, CF₃(CF₂)₇SO₃⁻, CF₃CO₂⁻, CH₃CO₂⁻, SCN⁻, and (CF₃CF₂SO₂)₂N⁻ as an anion. Also, the lithium salt may be one or a mixture of two or more thereof as necessary.

The lithium salt may be included at a concentration of 0.5 to 3 M in the non-aqueous electrolyte for a lithium secondary battery.

In this case, when a concentration of the lithium salt is 0.5 M or less, an effect of improving low-temperature output and high-temperature cycle characteristics of a battery may be insignificant, and when a concentration thereof is greater than 3 M, a swelling phenomenon caused by an excessive occurrence of a side reaction in an electrolyte upon charging and discharging of a battery may occur, or the corrosion of a positive electrode or a negative electrode current collector made of a metal in an electrolyte may be caused.

In addition, in the non-aqueous electrolyte according to the present invention, the non-aqueous organic solvent may include a mixed solvent in which a cyclic carbonate-based compound which is a high-viscosity organic solvent and a linear carbonate-based compound which is a low-viscosity organic solvent are mixed in a weight ratio of 90:10 to 10:90.

When a weight ratio of the cyclic carbonate-based compound is greater than 90, charging/discharging efficiency may be degraded due to high viscosity. Also, when a weight ratio of the cyclic carbonate-based compound is less than 10, a lithium salt may be not easily dissociated due to a low dielectric constant. As such, in the present invention, a non-aqueous electrolyte having higher ion conductivity may be prepared by using a mixed solvent in which a cyclic carbonate-based compound having high viscosity and a linear carbonate-based compound having low viscosity and a low dielectric constant are mixed in an appropriate ratio as a non-aqueous organic solvent.

The cyclic carbonate-based compound is not limited as long as it may be minimally decomposed by an oxidation reaction or the like during a charging and discharging process of a battery, and may exhibit a desired characteristic when being used together with an additive. Representative examples thereof include any one or a mixture of two or more selected from the group consisting of ethylene carbonate (EC), propylene carbonate (PC), 1,2-butylene carbonate (BC), 2,3-butylene carbonate, 1,2-pentylene carbonate, 2,3-pentylene carbonate, vinylene carbonate (VC), and a halide thereof such as fluoroethylene carbonate (FEC). Particularly, among the cyclic carbonate-based compounds, PC, EC, or a mixture thereof is more preferably used because it dissociates a lithium salt in an electrolyte effectively due to its high dielectric constant.

Also, specific examples of the linear carbonate-based compound include any one or a mixture of two or more selected from the group consisting of dimethyl carbonate (DMC), diethyl carbonate (DEC), dipropyl carbonate (DPC), ethyl methyl carbonate (EMC), methyl propyl carbonate (MPC), and ethyl propyl carbonate (EPC).

In addition, the non-aqueous electrolyte according to the present invention may further include, for the purpose of improving initial capacity, an ester-based compound in addition to the non-aqueous organic solvent as necessary.

Representative examples of the ester-based compound include any one or a mixture of two or more selected from the group consisting of methyl acetate, ethyl acetate, propyl acetate, propyl propionate (PP), ethyl propionate (EP), methyl propionate (MP), γ-butyrolactone, γ-valerolactone, γ-caprolactone, δ-valerolactone, and ε-caprolactone. Particularly, among these, PP, EP, MP, all of which have low viscosity, or a mixture of two or more thereof may be used.

As described above, the non-aqueous electrolyte according to the present invention includes an additive including a compound represented by Formula 1 and a mixed organic solvent including a cyclic carbonate-based compound, a linear carbonate-based compound, and optionally, an ester-based compound so that a secondary battery which is capable of effectively suppressing a large amount of gas generated during an initial charging and discharging process and consequently minimizing a swelling phenomenon which may occur when the battery is stored at high temperature may be manufactured.

In addition, according to another embodiment of the present invention, there is provided a lithium secondary battery which includes a positive electrode, a negative electrode, a separator interposed between the positive electrode and the negative electrode, and the non-aqueous electrolyte according to the present invention.

Specifically, the lithium secondary battery according to the present invention may be manufactured by injecting the non-aqueous electrolyte according to the present invention into an electrode assembly composed of the positive electrode, the negative electrode, and the separator interposed between the positive electrode and the negative electrode.

In this case, the positive electrode may be manufactured by applying a positive electrode mixture including a positive electrode active material and optionally including a binder, a conductive material, a solvent and the like on a positive electrode current collector.

The positive electrode current collector is not particularly limited as long as it does not cause a chemical change in the battery and has conductivity. For example, stainless steel, aluminum, nickel, titanium, calcined carbon, or aluminum or stainless steel whose surface is treated with carbon, nickel, titanium, silver or the like may be used as the positive electrode current collector.

The positive electrode active material may be a compound capable of reversible intercalation and deintercalation of lithium ions, and particularly, may include a lithium composite metal oxide containing lithium and one or more metals such as cobalt, manganese, nickel or aluminum. More particularly, the lithium composite metal oxide may be any one or a mixture of two or more of lithium-manganese-based oxides (e.g., LiMnO₂, LiMn₂O₄ or the like), lithium-cobalt-based oxides (e.g., LiCoO₂ or the like), lithium-nickel-based oxides (e.g., LiNiO₂ or the like), lithium-nickel-manganese-based oxides (e.g., LiNi_{1-Y}Mn_{Y}O₂ (here, 0<Y<1), LiMn_{2-z}Ni_{z}O₄ (here, 0<Z<2) or the like), lithium-nickel-cobalt-based oxides (e.g., LiNi_{1-Y1}Co_{Y1}O₂ (here, 0<Y1<1) or the like), lithium-manganese-cobalt-based oxides (e.g., LiCo_{1-Y2}Mn_{Y2}O₂ (here, 0<Y2<1), LiMn_{2-Z1}Co_{Z1}O₄ (here, 0<Z1<2) or the like), lithium-nickel-manganese-cobalt-based oxides (e.g., Li(NiₚCo_{q}Mnᵣ₁)O₂ (here, 0<p<1, 0<q<1, 0<r1<1, and p+q+r1=1), Li(Niₚ₁Co_{q1}Mnᵣ₂)O₄ (here, 0<p1<2, 0<q1<2, 0<r2<2, and p1+q1+r2=2) or the like), or lithium-nickel-cobalt-transition metal (M) oxides (e.g., Li(Niₚ₂Co_{q2}Mnᵣ₃M_{S2})O₂ (here, M is selected from the group consisting of Al, Fe, V, Cr, Ti, Ta, Mg and Mo, and p2, q2, r3 and s2 represent an atomic fraction of each independent element, and satisfy 0<p2<1, 0<q2<1, 0<r3<1, 0<s2<1, and p2+q2+r3+s2=1) or the like). Among these, in view of possibly increasing the capacity characteristic and stability of the battery, the lithium composite metal oxide may be LiCoO₂, LiMnO₂, LiNiO₂, a lithium-nickel-manganese-cobalt-based oxide (e.g., Li(Ni_{0.6}Mn_{0.2}Co_{0.2})O₂, Li(Ni_{0.5}Mn_{0.3}Co_{0.2})O₂, Li(Ni_{0.7}Mn0.15Co_{0.15})O₂, Li(Ni_{0.8}Mn_{0.1}Co_{0.1})O₂ or the like), or a lithium-nickel-cobalt-aluminum-based oxide (e.g., Li(Ni_{0.8}Co_{0.15}Al_{0.05})O₂ or the like). In consideration of the remarkableness of an improvement effect according to control of types and content ratios of components constituting the lithium composite metal oxide, the lithium composite metal oxide may be any one or a mixture of two or more selected from Li(Ni_{0.6}Mn_{0.2}Co_{0.2})O₂, Li(Ni_{0.5}Mn_{0.3}Co_{0.2})O₂, Li(Ni_{0.7}Mn_{0.15}Co_{0.15})O₂, or Li(Ni_{0.8}Mn_{0.1}Co_{0.1})O₂.

The positive electrode active material may be included at 80 to 99 wt % based on the total weight of the positive electrode mixture.

The binder is a component that assists binding between an active material and a conductive material and binding to a current collector, and is commonly added at 1 to 30 wt % based on the total weight of the positive electrode mixture. Such a binder is, for example, polyvinylidene fluoride (PVDF), polyvinyl alcohol, carboxymethyl cellulose (CMC), starches, hydroxypropyl cellulose, regenerated cellulose, polyvinyl pyrrolidone, tetrafluoroethylene, polyethylene, polypropylene, an ethylene-propylene-diene terpolymer (EPDM), a sulfonated EPDM, styrene-butadiene rubber, fluororubber, one of various copolymers thereof or the like.

The conductive material is commonly added at 1 to 30 wt % based on the total weight of the positive electrode mixture.

Such a conductive material is not particularly limited as long as it does not cause a chemical change in the battery and has conductivity. For example, the conductive material is graphite; a carbon-based material such as carbon black, acetylene black, Ketjen black, channel black, furnace black, lamp black, thermal black or the like; a conductive fiber such as carbon fiber, metallic fiber or the like; metallic powder such as carbon fluoride powder, aluminum powder, nickel powder or the like; a conductive whisker such as zinc oxide, potassium titanate or the like; a conductive metal oxide such as titanium oxide or the like; or a conductive material such as a polyphenylene derivative or the like. Specific examples of a commercially available conductive material include the acetylene black series (commercially available from Chevron Chemical Company), Denka black (Denka Singapore Private Limited or Gulf Oil Company products), Ketjen black, the EC series (commercially available from Armak Company), Vulcan XC-72 (commercially available from Cabot Company) and Super P (commercially available from Timcal).

The solvent may be an organic solvent such as N-methyl-2-pyrrolidone (NMP) or the like and may be used in an amount in which preferable viscosity is exhibited when a positive electrode active material and optionally a binder, a conductive material and the like are included. For example, the solvent may be included in such a way that a solid concentration including a positive electrode active material and optionally including a binder, and a conductive material is 50 to 95 wt %, preferably, 70 to 90 wt %.

The negative electrode may be manufactured, for example, by applying a negative electrode mixture including a negative electrode active material, a binder, a conductive material, a solvent, and the like on a negative electrode current collector.

The negative electrode current collector generally has a thickness of 3 to 500 μm. Such a negative electrode current collector is not particularly limited as long as it does not cause a chemical change in the battery and has high conductivity. For example, copper, stainless steel, aluminum, nickel, titanium, calcined carbon, copper or stainless steel whose surface is treated with carbon, nickel, titanium, silver, or the like, an aluminum-cadmium alloy, or the like may be used as the negative electrode current collector. Also, the negative electrode current collector, like the positive electrode current collector, may have fine irregularities at a surface thereof to increase adhesion of the negative electrode active material. In addition, the negative electrode current collector may be used in any of various forms such as a film, a sheet, a foil, a net, a porous material, a foam, a non-woven fabric, and the like.

The negative electrode active material may be one or two or more selected from the group consisting of natural graphite, artificial graphite or a carbon material; a metal (Me) such as lithium-containing titanium composite oxide (LTO), Si, Sn, Li, Zn, Mg, Cd, Ce, Ni or Fe; an alloy composed of the metal (Me); an oxide of the metal (Me); and a composite of the metal (Me) and carbon.

The negative electrode active material may be included at 80 to 99 wt % based on the total weight of the negative electrode mixture.

The binder is a component that assists binding between a conductive material, an active material, and a current collector, and is commonly added at 1 to 30 wt % based on the total weight of the negative electrode mixture. Such a binder is, for example, PVDF, polyvinyl alcohol, CMC, starches, hydroxypropyl cellulose, regenerated cellulose, polyvinyl pyrrolidone, tetrafluoroethylene, polyethylene, polypropylene, an ethylene-propylene-diene polymer (EPDM), a sulfonated EPDM, styrene-butadiene rubber, fluororubber, one of various copolymers thereof or the like.

The conductive material is a component for further improving the conductivity of the negative electrode active material and may be added at 1 to 20 wt % based on the total weight of the negative electrode mixture. Such a conductive material is not particularly limited as long as it does not cause a chemical change in the battery and has conductivity. For example, graphite such as natural graphite, artificial graphite or the like; carbon black such as acetylene black, Ketjen black, channel black, furnace black, lamp black, thermal black or the like; a conductive fiber such as carbon fiber, metallic fiber or the like; metallic powder such as carbon fluoride powder, aluminum powder, nickel powder or the like; a conductive whisker such as zinc oxide, potassium titanate or the like; a conductive metal oxide such as titanium oxide or the like; or a conductive material such as a polyphenylene derivative or the like may be used as the conductive material.

The solvent may be water or an organic solvent such as NMP or the like, and may be used in an amount in which preferable viscosity is exhibited when a negative electrode active material and optionally a binder, a conductive material and the like are included. For example, the solvent may be included in such a way that a solid concentration including a negative electrode active material and optionally including a binder and a conductive material is 50 to 95 wt %, preferably, 70 to 90 wt %.

In addition, the separator may be a porous polymer film, for example, a porous polymer film made of a polyolefin-based polymer such as an ethylene homopolymer, a propylene homopolymer, an ethylene/butene copolymer, an ethylene/hexene copolymer, an ethylene/methacrylate copolymer or the like, or a stacked structure having two or more layers made thereof. Alternatively, the separator may be a common porous non-woven fabric, for example, a non-woven fabric made of glass fiber with a high melting point, polyethylene terephthalate fiber or the like, but the present invention is not limited thereto.

The appearance of the lithium secondary battery according to the present invention is not particularly limited, but it may be in any of various forms such as a cylindrical form, a prismatic form, a pouch form, a coin form and the like, which use a can.

### MODE FOR INVENTION

Hereinafter, the present invention will be described in detail with reference to embodiments. However, embodiments of the present invention may be modified in several different forms, and the scope of the present invention is not limited to the embodiments to be described below. The embodiments of the present invention are provided so that this disclosure will be thorough and complete, and will fully convey the concept of embodiments to those skilled in the art.

### EXAMPLES

### Example 1

(Preparation of Electrolyte)

Ethylene carbonate (EC), propylene carbonate (PC), and diethyl carbonate (DEC) were mixed in a weight ratio of 30:10:60 to prepare a non-aqueous organic solvent, LiPF₆ was dissolved in the non-aqueous organic solvent at a concentration of 1.0 M, and then an allyltrimethylsilane compound represented by Formula 1a was added in an amount of 0.4 parts by weight based on 100 parts by weight of a non-aqueous electrolyte to the resulting solvent to prepare a non-aqueous electrolyte.

(Manufacture of Positive Electrode)

40 parts by weight of a positive electrode mixture, in which a positive electrode active material (LiCoO2), a conductive material (carbon black), and a binder (PVDF) were mixed in a weight ratio of 96:2:2 based on 100 parts by weight of N-methyl-2-pyrrolidone (NMP) as a solvent, was added to prepare a positive electrode mixture. The positive electrode mixture was applied on a positive electrode current collector (Al thin film) having a thickness of 20 μm, dried, and roll-pressed to manufacture a positive electrode.

(Manufacture of Negative Electrode)

90 parts by weight of a negative electrode mixture, in which natural graphite, a binder (PVDF), and a conductive material (carbon black) were mixed in a weight ratio of 96:3:1 based on 100 parts by weight of NMP as a solvent, was added to prepare a negative electrode mixture. The negative electrode mixture was applied on a negative electrode current collector (Cu thin film) having a thickness of 10 μm, dried, and roll-pressed to manufacture a negative electrode.

(Manufacture of Secondary Battery)

A secondary battery was manufactured by a common method in which the positive electrode and the negative electrode manufactured by the above-described methods were sequentially laminated together with a separator composed of three layers of polypropylene/polyethylene/polypropylene (PP/PE/PP). Afterward, 3.5 mL of the prepared non-aqueous electrolyte was injected to manufacture a pouch-type lithium secondary battery.

### Comparative Example 1

A non-aqueous electrolyte and a lithium secondary battery including the same were manufactured in the same manner as in Example 1 except that a non-aqueous electrolyte additive was not added when a non-aqueous electrolyte was prepared in Example 1.

### Comparative Example 2

A non-aqueous electrolyte and a lithium secondary battery including the same were manufactured in the same manner as in Example 2 except that a non-aqueous electrolyte additive was not added when a non-aqueous electrolyte was prepared in Example 1.

### Comparative Example 3

A non-aqueous electrolyte and a lithium secondary battery including the same were manufactured in the same manner as in Example 1 except that ethyl propionate (EP), which is an ester solvent, was included as an organic solvent instead of DEC when a non-aqueous electrolyte was prepared in Example 1.

### Reference Example 1

A non-aqueous electrolyte and a lithium secondary battery including the same were manufactured in the same manner as in Example 1 except that a non-aqueous electrolyte additive was added in an amount of 1.2 parts by weight when a non-aqueous electrolyte was prepared in Example 1.

### Reference Example 2

A non-aqueous electrolyte and a lithium secondary battery including the same were manufactured in the same manner as in Example 1 except that a non-aqueous electrolyte additive was added in an amount of 0.09 parts by weight when a non-aqueous electrolyte was prepared in Example 1.

### EXPERIMENTAL EXAMPLES

### Experimental Example 1

Each of the lithium secondary battery manufactured in Example 1, the lithium secondary batteries manufactured in Comparative Examples 1 to 3, and the lithium secondary batteries manufactured in Reference Examples 1 and 2 was vacuum-sealed at −85 kPa, then wet for 2 days, and charged at constant current (0.2 C rate) until a current reached ⅙ C of 1 C capacity.

Subsequently, an initial thickness of the lithium secondary battery after shipping charge was measured using a plating thickness gauge including a weight of 300 g. A result thereof is shown in Table 1 below.

In addition, the lithium secondary battery in which the shipping charge was completed was discharged at a current of 0.2 C rate until 3 V, charged at constant current/constant voltage (1.2 C/4.2 V) until a current reached 1/20 mA of 1 C current, and discharged again at a current of 0.2 C until 3 V. Discharge capacity in the last step was defined as initial capacity, and a resulting value is shown in Table 1 below.

TABLE 1

| | | | Thickness | |
|---|---|---|---|---|
| | Content of | | after shipping | Initial |
| | Formula 1a | Organic solvent | charge | capacity |
| | additive | (weight ratio) | (mm) | (mAh) |
| Example 1 | 0.4 parts by | EC/PC/DEC = | 4.17 | 1278.5 |
| | weight | 30:10:60 | | |
| Comparative | — | EC/PC/DEC = | 4.21 | 1262.8 |
| Example 1 | | 30:10:60 | | |
| Comparative | — | EC/PC/EP = | 4.21 | 1289.8 |
| Example 2 | | 30:10:60 | | |
| Comparative | 0.4 parts by | EC/PC/EP = | 4.19 | 1290.7 |
| Example 3 | weight | 30:10:60 | | |
| Reference | 1.2 parts by | EC/PC/DEC = | 4.16 | 1264.2 |
| Example 1 | weight | 30:10:60 | | |
| Reference | 0.09 parts by | EC/PC/DEC = | 4.21 | 1263.1 |
| Example 2 | weight | 30:10:60 | | |

Referring to Table 1, it can be seen that, when a change in a battery thickness after shipping charge was measured, each of the secondary batteries according to Example 1 and Comparative Example 3, in which the non-aqueous electrolyte including an additive according to the present invention was added, had a thickness of 4.17 mm and 4.19 mm, which indicates a slightchange in a battery thickness compared to the secondary batteries according to Comparative Examples 1 and 2 in which a non-aqueous electrolyte not including an additive is added (4.21 mm) and the secondary battery according to Reference Example 2 in which a non-aqueous electrolyte including a small amount, that is, 0.09 parts by weight, of an additive was added (4.21 mm). From the above-described results, it can be seen that, when a non-aqueous electrolyte including an additive was added, a swelling phenomenon was suppressed, thereby exhibiting a slight change in a battery thickness.

In addition, it can be seen that the secondary battery according to Example 1 of the present invention had an initial capacity of 1,278.5 mAh, and the secondary battery according to Comparative Example 3 had an initial capacity of 1,290.7 mAh, which indicate improved capacity compared to initial capacity of the secondary battery according to Comparative Example 1 in which a non-aqueous electrolyte not including an additive was added (1,262.8 mAh), initial capacity of the secondary battery according to Reference Example 1 in which a non-aqueous electrolyte including an excessive amount, that is, 1.2 parts by weight, of an additive was added (1,264.2 mAh), and initial capacity of the secondary battery according to Reference Example 2 in which a non-aqueous electrolyte including a small amount, that is, 0.09 parts by weight, of an additive was added (1,263.1 mAh). From the above-described results, it is possible to predict that, when a non-aqueous electrolyte including an excessive or small amount of an additive is added, since it is difficult to form a stable film and thus internal resistance of the battery increases, initial capacity is degraded.

Meanwhile, it can be seen that, compared to the secondary battery of Example 1 which includes a cyclic carbonate-based compound and a linear carbonate-based compound as an organic solvent, the secondary battery of Comparative Example 3 which includes a cyclic carbonate-based compound and an ester-based compound as an organic solvent, exhibited an increase in initial capacity and a slight increase in a battery thickness after shipping charge.

### Experimental Example 2. Evaluation of Performance Upon High-Temperature Storage

The secondary batteries according to Example 1 and Comparative Examples 1 to 3 were charged at constant current/constant voltage (0.7 C/4.2 V) until a current reached 1/20 mA of 1 C current, heated from room temperature to 90° C. for 1 hour, and then maintained at 90° C. for 4 hours. After the test was completed, residual capacities and thickness change rates of the batteries were measured, results of which are shown in Table 2 below. In this case, a thickness of the battery was measured using a plating thickness gauge including a weight of 500 g.

*Thickness increase rate (%)={(Thickness after high-temperature storage−Initial thickness upon full charging)/Initial thickness upon full charging}×100

*Capacity recovery rate (%)=(Residual capacity/Initial capacity)×100

TABLE 2

| | | | | Initial | Thickness | |
|---|---|---|---|---|---|---|
| | | | Capacity | thickness | after high- | Thickness |
| | Initial | Residual | recovery | upon full | temperature | increase |
| | capacity | capacity | rate | charging | storage | rate |
| | (mAh) | (mAh) | (%) | (mm) | (mm) | (%) |
| Example 1 | 1278.5 | 1191.2 | 93.2 | 4.72 | 4.93 | 4.4 |
| Comparative | 1262.8 | 1132.0 | 89.6 | 4.76 | 5.24 | 10.1 |
| Example 1 | | | | | | |
| Comparative | 1289.8 | 1162.1 | 90.1 | 4.76 | 5.29 | 11.1 |
| Example 2 | | | | | | |
| Comparative | 1290.7 | 1164.2 | 90.2 | 4.74 | 5.26 | 11.0 |
| Example 3 | | | | | | |

Referring to Table 2, it can be seen that the secondary battery according to Example 1 exhibited slight improvements in most of residual capacity, capacity recovery rate, initial thickness change rate of the battery upon full charging, and thickness change rate of the battery after high-temperature storage compared to the secondary batteries according to Comparative Examples 1 to 3. Particularly, the secondary battery according to Example 1 exhibited an effect of improving a thickness change rate about 50% after being stored at high temperature compared to the secondary batteries according to Comparative Examples 1 to 3. From the above-described results, it is possible to predict that the secondary battery according to Example 1, in which a non-aqueous electrolyte including an additive according to the present invention was added, was more excellent in suppressing a swelling phenomenon when stored at high temperature because a stable SEI film was formed due to the additive.

1. A non-aqueous electrolyte comprising:
a lithium salt;
an organic solvent; and
an additive,
wherein the organic solvent includes a cyclic carbonate and a linear carbonate, and the additive includes a compound represented by Formula 1 below. 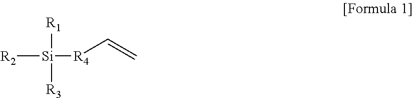
in Formula 1,
R₁ to R₃ are each independently a C1 to C3 alkyl group, and R₄ is a C1 to C3 alkylene group.

2. The non-aqueous electrolyte of claim 1, wherein the additive of the non-aqueous electrolyte is included at 0.1 to 1 part by weight based on a total of 100 parts by weight of the non-aqueous electrolyte.

3. The non-aqueous electrolyte of claim 1, wherein the additive of the non-aqueous electrolyte is included at 0.1 to 0.5 parts by weight based on a total of 100 parts by weight of the non-aqueous electrolyte.

4. The non-aqueous electrolyte of claim 1, wherein the additive includes a compound represented by Formula 1a below.

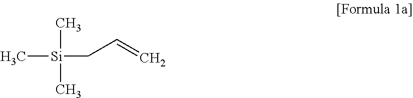

5. The non-aqueous electrolyte of claim 1, wherein the lithium salt includes Li⁺ as a cation and at least one selected from the group consisting of F⁻, Cl⁻, Br⁻, I⁻, NO₃⁻, N(CN)₂⁻, BF₄⁻, ClO₄⁻, AlO₄⁻, AlCl₄⁻, PF₆⁻, SbF₆⁻, AsF₆⁻, BF₂C₂O₄⁻, BC₄O₈⁻, (CF₃)₂PF₄⁻, (CF₃)₃PF₃⁻, (CF₃)₄PF₂⁻, (CF₃)₅PF⁻, (CF₃)₆P⁻, CF₃SO₃⁻, C₄F₉SO₃⁻, CF₃CF₂SO₃⁻, (CF₃SO₂)₂N⁻, (F₂SO₂)₂N⁻, CF₃CF₂(CF₃)₂CO⁻, (CF₃SO₂)₂CH⁻, (SF₅)₃C⁻, (CF₃SO₂)₃C⁻, CF₃(CF₂)₇SO₃⁻, CF₃CO₂⁻, CH₃CO₂⁻, SCN⁻, and (CF₃CF₂SO₂)₂N⁻ as an anion.

6. The non-aqueous electrolyte of claim 1, wherein the organic solvent is a mixed solvent including the cyclic carbonate and the linear carbonate in a weight ratio of 90:10 to 10:90.

7. The non-aqueous electrolyte of claim 6, wherein the cyclic carbonate-based compound includes any one or a mixture of two or more selected from the group consisting of ethylene carbonate (EC), propylene carbonate (PC), 1,2-butylene carbonate (BC), 2,3-butylene carbonate, 1,2-pentylene carbonate, 2,3-pentylene carbonate, vinylene carbonate (VC), and fluoroethylene carbonate (FEC).

8. The non-aqueous electrolyte of claim 6, wherein the linear carbonate-based compound includes any one or a mixture of two or more selected from the group consisting of dimethyl carbonate (DMC), diethyl carbonate (DEC), dipropyl carbonate (DPC), ethyl methyl carbonate (EMC), methyl propyl carbonate (MPC), and ethyl propyl carbonate (EPC).

9. A lithium secondary battery comprising a negative electrode, a positive electrode, a separator interposed between the negative electrode and the positive electrode, and a non-aqueous electrolyte,
wherein the non-aqueous electrolyte comprise the non-aqueous electrolyte of claim 1.
